(19) United States
(12) Patent Application Publication
(10) Pub. No.: US 2020/0035214 A1
(43) Pub. Date: Jan. 30, 2020

(54) SIGNAL PROCESSING DEVICE

(71) Applicant: Mitsubishi Electric Corporation, Tokyo (JP)

(72) Inventor: Nobuaki TANAKA, Tokyo (JP)

(73) Assignee: Mitsubishi Electric Corporation, Tokyo (JP)

(21) Appl. No.: 16/482,396

(22) PCT Filed: Mar. 16, 2017
(86) PCT No.: PCT/JP2017/010714

§ 371 Date: Jul. 31, 2019

(51) Int. Cl. G10K 11/34; H04R 1/40; H04R 3/00

(52) U.S. Cl. CPC G10K 11/341; H04R 3/00; H04R 1/406

(57) ABSTRACT

A filter coefficient vector generating unit (3) generates a filter coefficient vector used for forming directivity in a target direction by using beamforming, while suppressing the filter coefficient vector in such a way that the filter coefficient vector has a value equal to or less than a setting value. A beamforming unit (4) performs the beamforming on the basis of both observation signals acquired from a microphone array (2), and the filter coefficient vector generated by the filter coefficient vector generating unit (3), to form directivity in the target direction, and outputs a signal in which a sound having the formed directivity is emphasized.

### TECHNICAL FIELD

The present disclosure relates to a signal processing device that acquires a signal in which a sound coming from a specific direction is emphasized by performing signal processing on observation signals acquired from a sensor array including multiple sonic sensors.

### BACKGROUND ART

A signal processing device can emphasize a sound (target sound) that comes from a direction desired by a user and suppress other sounds (disturbing sounds) by using a sensor array including multiple sonic sensors (e.g., microphones) and performing predetermined signal processing on an observation signal acquired from each of the multiple sonic sensors.

With this device, for example, it is possible to make clear a sound that is difficult to catch because of a noise occurring from equipment such as an air conditioner, and emphasize only a desired speaker's utterance when multiple speakers are uttering simultaneously.

The technique as mentioned above can not only make a sound easy to be caught by human beings, but also improve the robustness against noises in voice recognition systems or the likes. Further, in addition to making a human being's utterance clear, for example, in an equipment monitoring system that automatically determines whether or not an abnormal sound is included in an operating sound from equipment, the technique can be used for a purpose or the like of preventing the accuracy of the determination from degrading because of a surrounding noise.

Various methods of forming directivity by using a sensor array and performing signal processing have been disclosed conventionally. For example, in Nonpatent Literature 1, a technique for forming directivity by using linear beamforming is disclosed. The linear beamforming has an advantage of reducing degradation in the sound quality of an output signal in comparison with a method of involving nonlinear signal processing.

### CITATION LIST

### Nonpatent Literature

Nonpatent Literature 1: Ikuma Ikeda, Akira Omoto, “Study for 5.1 surround reproduction in 80-channel microphone array sound collecting system,” Lectures of the Acoustical Society of Japan, pp. 587-588, September 2012.

### SUMMARY OF INVENTION

### Technical Problem

Although in the above-mentioned conventional technique, after directivity in a target direction desired by a user is provided, a filter coefficient vector is generated in such a way that a squared error between the directivity in the target direction and the directivity actually formed is minimized, no constraint is imposed on the magnitude of the absolute value of each of the elements that constitute the generated filter coefficient vector.

When there is no constraint on the magnitude of the filter coefficient vector, there is a case in which the absolute value of each of the elements that constitute the filter coefficient vector is very large dependently on a target frequency or the arrangement of microphones. Although when an element having a large absolute value is included in the filter coefficient vector, a correct output signal can be acquired theoretically by performing beamforming by using the filter coefficient vector, an individual difference between the sonic sensors or an electrical noise also exists in an actual environment, and therefore their influences are increased and a bad influence is exerted on the output signal.

Because when the influence of the individual difference between the sonic sensors is increased, the deviation between the directivity in the target direction and the directivity actually formed becomes large, there is a possibility that a sound (target sound) coming from the target direction is not emphasized or other sounds (disturbing sounds) are emphasized.

Further, when an electrical noise is increased, there is a possibility that, in comparison with the signal level of the target sound included in the output signal, the signal level of the electrical noise is emphasized up to a perceivable level also in human auditory sense, and the sound quality degrades remarkably.

The present disclosure is made in order to solve the above-mentioned problem, and it is therefore an object of the present disclosure to provide a signal processing device that can avoid degradation in the sound quality of an output signal, the degradation being caused by an individual difference between sonic sensors or electrical noises.

### Solution to Problem

A signal processing device according to the present disclosure includes: multiple sonic sensors; a filter coefficient vector generating unit for generating a filter coefficient vector used for forming directivity in a target direction by using beamforming, while suppressing the filter coefficient vector in such a way that the filter coefficient vector has a value equal to or less than a setting value; and a beamforming unit for performing the beamforming on the basis of both observation signals acquired from the respective multiple sonic sensors, and the filter coefficient vector generated by the filter coefficient vector generating unit, to form directivity in the target direction, and for outputting a signal in which a sound having the formed directivity is emphasized.

### Advantageous Effects of Invention

The signal processing device according to the present disclosure generates a filter coefficient vector used for forming directivity in a target direction by using the beamforming, while suppressing the filter coefficient vector in such a way that the filter coefficient vector has a value equal to or less than the setting value. As a result, degradation in the sound quality of the output signal, the degradation being caused by an individual difference between the sonic sensors or electrical noises, can be avoided.

### BRIEF DESCRIPTION OF DRAWINGS

FIG. 1 is a block diagram of a signal processing device according to Embodiment 1 of the present disclosure;

FIG. 2 is a hardware block diagram of the signal processing device according to Embodiment 1 of the present disclosure;

FIG. 3 is a hardware block diagram of another example of the signal processing device according to Embodiment 1 of the present disclosure;

FIG. 4 is a block diagram showing the details of a beamforming unit in the signal processing device of Embodiment 1 of the present disclosure;

FIG. 5 is an explanatory drawing showing an example of a microphone including four microphones in the signal processing device of Embodiment 1 of the present disclosure;

FIG. 6 is an explanatory drawing showing ideal directivity of the signal processing device of Embodiment 1 of the present disclosure;

FIG. 7 is an explanatory drawing of calculatedly-acquired directivity in the signal processing device of Embodiment 1 of the present disclosure;

FIG. 8 is an explanatory drawing showing a norm for each frequency in the signal processing device of Embodiment 1 of the present disclosure;

FIG. 9 is an explanatory drawing showing directivity in a case of using singular value decomposition in the signal processing device of Embodiment 1 of the present disclosure;

FIG. 10 is an explanatory drawing showing a norm for each frequency in the case of FIG. 9 in the signal processing device of Embodiment 1 of the present disclosure;

FIG. 11 is a flowchart showing the operation of a filter coefficient vector generating unit in the signal processing device of Embodiment 1 of the present disclosure;

FIG. 12 is an explanatory drawing showing a norm for each frequency in a signal processing device of Embodiment 2 of the present disclosure;

FIG. 13 is a flowchart showing the operation of a filter coefficient vector generating unit in the signal processing device of Embodiment 2 of the present disclosure;

FIG. 14 is an explanatory drawing showing a norm for each frequency in a signal processing device of Embodiment 3 of the present disclosure; and

FIG. 15 is a flowchart showing the operation of a filter coefficient vector generating unit in the signal processing device of Embodiment 3 of the present disclosure.

### DESCRIPTION OF EMBODIMENTS

Hereafter, in order to explain the present disclosure in greater detail, embodiments of the present disclosure will be described with reference to the accompanying drawings. In the following embodiments, a sensor array will be explained, as a microphone array, using omnidirectional microphones as a concrete example of sonic sensors. However, the sonic sensors in the present disclosure are not limited to omnidirectional microphones, and it is assumed that, for example, directional microphones, ultrasonic sensors, etc. are included in the sonic sensors.

### Embodiment 1

FIG. 1 is a block diagram of a signal processing device according to this embodiment.

The illustrated signal processing device 1 includes: a microphone array 2 provided with multiple microphones; a filter coefficient vector generating unit 3; and a beamforming unit 4. The microphone array 2 is configured so as to perform A/D conversion on analog sound signals observed by the multiple microphones 2-1 to 2-m, and output digital signals acquired thereby as observation signals. The filter coefficient vector generating unit 3 is a processing unit that generates a filter coefficient vector used for forming directivity in a direction desired by a user by using beamforming. Hereafter, the direction desired by a user is defined as the target direction.

It is further assumed that information about the target direction is provided for the filter coefficient vector generating unit 3 from the outside of the signal processing device 1. The filter coefficient vector includes information about a gain and a delay that are provided for an observation signal of each of the microphones included in the microphone array 2. At this time, the filter coefficient vector generating unit 3 suppresses the magnitude of the filter coefficient vector to be generated in such a way that the gain that the filter coefficient vector provides for the observation signal of each of the microphones is not excessive. The beamforming unit 4 is a processing unit that outputs a sound signal in which a sound coming from the target direction is emphasized on the basis of both the observation signal acquired from each of the microphones that constitute the microphone array 2, and the filter coefficient vector acquired from the filter coefficient vector generating unit 3. The details of this process will be explained later.

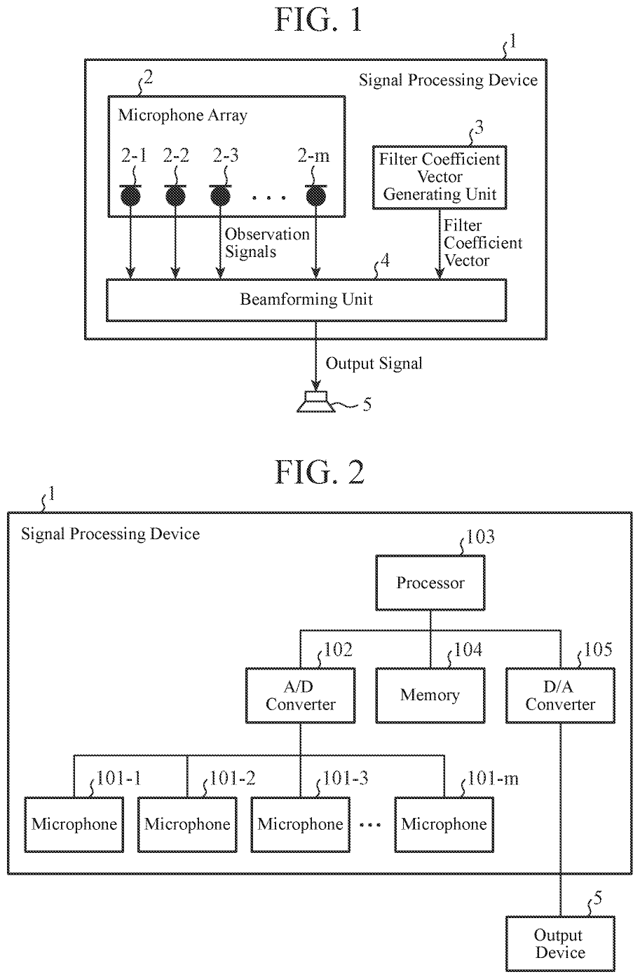

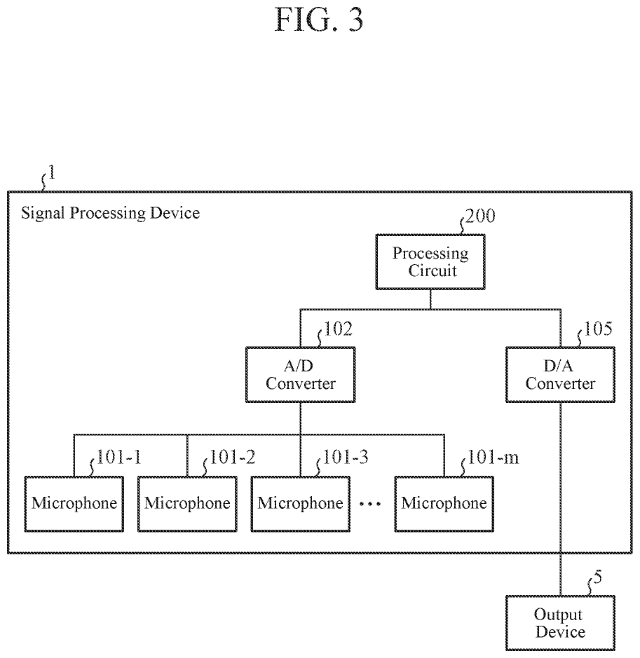

The filter coefficient vector generating unit 3 and the beamforming unit 4 are installed as, for example, either software on a computer or respective pieces of hardware for exclusive use. FIG. 2 is an example of the hardware configuration in a case in which the signal processing device is installed using a computer, and FIG. 3 is an example of the hardware configuration in a case in which the signal processing device is installed using hardware for exclusive use.

In the configuration of FIG. 2, the signal processing device 1 includes multiple microphones 101-1 to 101-m, an A/D converter 102, a processor 103, a memory 104, and a D/A converter 105. An output device 5 in the figure is the same as the output device 5 in FIG. 1. In a case in which the configuration of FIG. 1 is implemented by the hardware of FIG. 2, by developing, in the memory 104, a program that configures the functions of the filter coefficient vector generating unit 3 and the beamforming unit 4, and executing the program by the processor 103, the filter coefficient vector generating unit 3 and the beamforming unit 4 are implemented. The multiple microphones 101-1 to 101-m and the A/D converter 102 are included in the microphone array 2. Further, the D/A converter 105 is a circuit that converts a digital signal of the beamforming unit 4 into an analog signal in a case in which the output device 5 is driven by an analog signal.

Further, in the configuration of FIG. 3, multiple microphones 101-1 to 101-m, an A/D converter 102, a D/A converter 105, and a processing circuit 200 are included. The processing circuit 200 implements the functions of the filter coefficient vector generating unit 3 and the beamforming unit 4. Each of the other components is the same as that of FIG. 2.

The output device 5 outputs or stores the output signal from the beamforming unit 4 as a processing result of the signal processing device 1. For example, in a case in which the output device 5 is a speaker, from the speaker, the output signal is outputted as a sound. The output device 5 can alternatively be a storage medium such as a hard disc or a memory. In such a case, the output signal outputted from the beamforming unit 4 is recorded into the hard disc or the memory as digital data.

FIG. 4 is a block diagram of the signal processing device 1, the diagram showing the details of the beamforming unit 4.

As shown in the figure, the beamforming unit 4 includes DFT units 41, an observation signal vector generating unit 42, an inner product unit 43, and an IDFT unit 44. The DFT units 41 are circuits that are disposed while being associated with the respective microphones in the microphone array 2, and that each perform a discrete Fourier transform (DFT). The observation signal vector generating unit 42 is a circuit that integrates frequency spectra outputted from the respective DFT units 41 into one complex vector, and that outputs this complex vector. The inner product unit 43 is a circuit that calculates the inner product of the output from the observation signal vector generating unit 42 and the output from the filter coefficient vector generating unit 3. The IDFT unit 44 is a circuit that performs an inverse Fourier transform (IDFT) on an output from the inner product unit 43.

Next, the operation of the signal processing device 1 of Embodiment 1 will be explained using the configuration shown in FIG. 4. Here, a case in which the microphone array 2 includes M microphones 2-1 to 2-m is assumed, and an observation signal at a time t acquired from the m-th microphone is denoted by xₘ(t).

Observation signals outputted from the respective microphones 2-1 to 2-m are inputted to the respective DFT units 41, and each of the DFT units 41 performs a short-time discrete Fourier transform on the corresponding inputted signal and outputs a frequency spectrum acquired thereby. The frequency spectrum (complex number) outputted by the DFT unit 41 corresponding to the m-th microphone is denoted by Xₘ(τ, ω). τ denotes a short-time frame number, and ω denotes a discrete frequency.

The observation signal vector generating unit 42 integrates them frequency spectra outputted from the DFT units 41 into one complex vector x(τ, ω), as shown in the following equation (1), and outputs x(τ, ω). T denotes the transpose of a vector or a matrix.

x(τ,ω)=(X₁(τ,ω)) X₂(τ,ω) . . . X_{M}(τ,ω))^{T} (1)

The filter coefficient vector generating unit 3 outputs a filter coefficient vector w(ω) that is a complex vector having the same number (M) of elements as the complex vector x(τ, ω). A complex number that is the m-th element of the filter coefficient vector w(ω) shows, by its absolute value, the gain provided for the observation signal of the m-th microphone, and shows, by its argument, the delay provided for the observation signal. A method of generating appropriate w(ω) from the directivity in the target direction in the filter coefficient vector generating unit 3 will be mentioned later.

The inner product unit 43 calculates an inner product as shown in the following equation (2) from x(τ, ω) outputted from the observation signal vector generating unit 42 and the filter coefficient vector w(ω) outputted from the filter coefficient vector generating unit 3, and outputs Y(τ, ω) acquired as a result. Y(τ, ω) is a short-time discrete Fourier transform of the output signal.

Y(τ,ω)=w(ω)^{T}x(τ,ω) (2)

The IDFT unit 44 performs an inverse short time discrete Fourier transform on Y(τ, ω) outputted from the inner product unit 43, and outputs a final output signal y(t). In a case in which the filter coefficient vector w(ω) is designed properly, this output signal is a sound signal in which a sound having the directivity in the target direction is emphasized.

Next, a concrete method of generating an appropriate filter coefficient vector w(ω) from the directivity in the target direction in the filter coefficient vector generating unit 3 will be explained.

Here, N points at which the circumference of a circle centered at the microphone array 2 and having a size sufficiently larger than that of the microphone array is divided into N equal parts are considered. At this time, a steering vector (the number of elements is M) for an n-th point when viewed from the microphone array 2 is denoted by a_{ω, n}. Further, a matrix that is created by arranging N steering vectors in the following way is denoted by A(ω).

A(ω)=(a_{ω,1} a_{ω,2} . . . a_{ω,N})^{T} (3)

Next, a desired gain for a sound coming from the direction of the n-th point when viewed from the microphone array 2 is denoted by rₙ. Further, a vector that is created by arranging the desired gains corresponding to the N points in such a way as shown in the following equation is denoted by r. More specifically, r shows ideal directivity.

r=(r₁ r₂ . . . r_{N})^{T} (4)

When a squared error between the actually-formed directivity and the desired directivity is denoted by e, e can be expressed by the following equation (5).

e=∥A(ω)w(ω)−r∥² (5)

The filter coefficient vector w(ω) that minimizes e can be acquired as shown in the following equation (6) by differentiating e with respect to w(ω) and setting the differentiating result equal to 0. + denotes a Moore-Penrose pseudoinverse matrix.

w(ω)=A(ω)⁺r (6)

However, because when the equation (6) is used just as it is, no constraint is imposed on the magnitude of the absolute value of each of the elements of w(ω), there is a possibility that the magnitude of the absolute value becomes excessive dependently on a certain frequency band. In such a case, in an actual environment in which an individual difference between the microphones or an electrical noise exists, the sound quality of the output signal degrades remarkably.

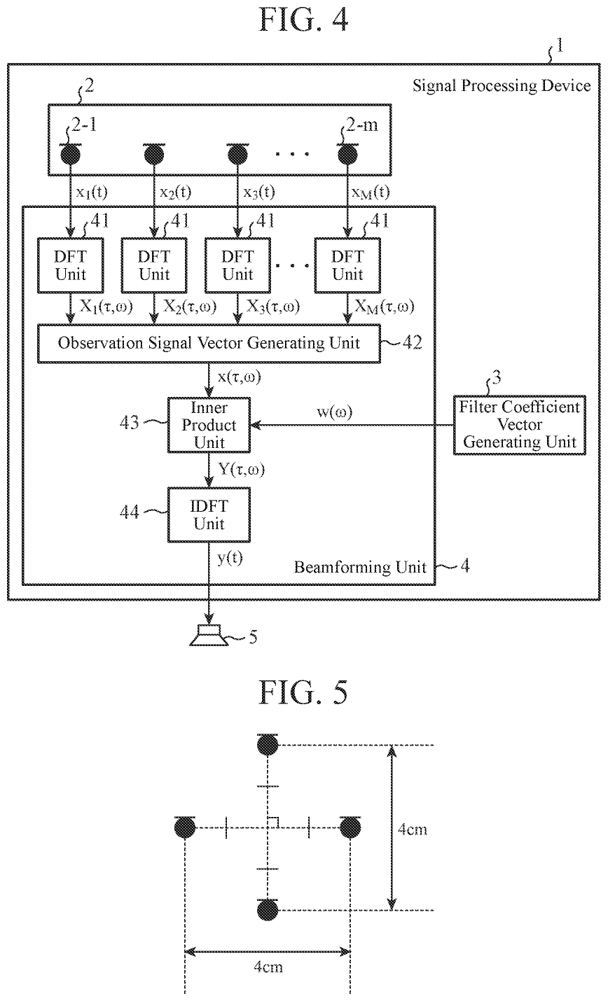

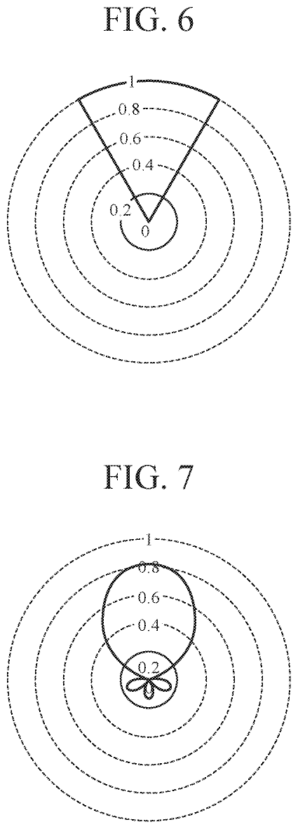

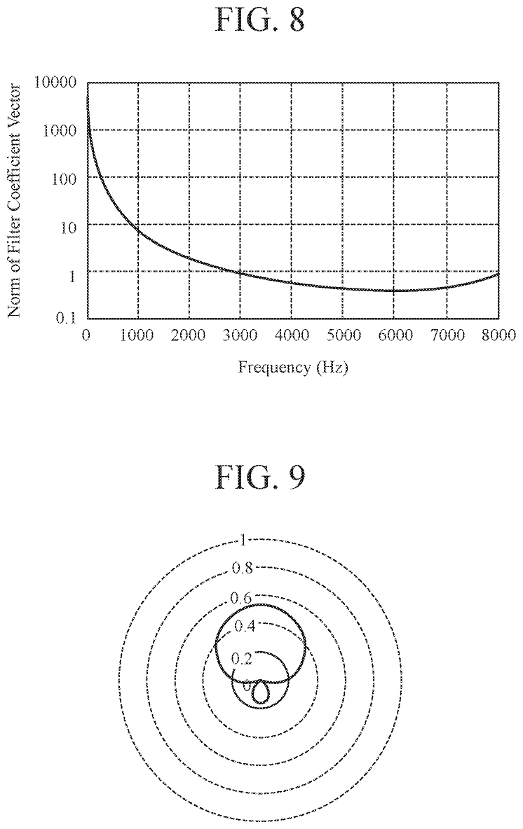

FIG. 5 is an example of the microphone including four microphones. These microphones are arranged at the respective vertices of a square whose diagonal lines each have a length of 4 cm. When this microphone array is used and w(ω) is simply calculated from the equation (6) after directivity shown in FIG. 6 is provided as the ideal directivity r, directivity as shown in FIG. 7 is calculatedly-acquired at 300 Hz, while the norm of w(ω) at each frequency is as shown in FIG. 8. Referring to FIG. 8, it is seen that the norm of w(ω) is remarkably large at especially low frequencies.

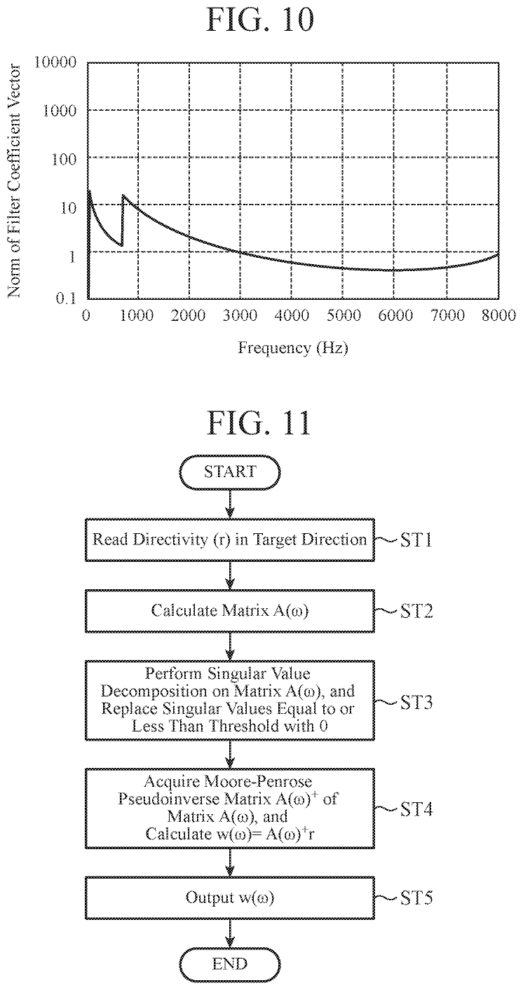

One of methods of suppressing the absolute value of each of the elements of the filter coefficient vector w(ω) in such a way that the absolute value does not become excessive is to use singular value decomposition when calculating the Moore-Penrose pseudoinverse matrix in the equation (6), to replace singular values close to 0 with 0. For example, when the microphone array shown in FIG. 5 is used and w(ω) is calculated using the equation (6) while FIG. 6 is provided as the ideal directivity r, the pseudoinverse matrix is calculated while singular values less than 0.1 are set to 0. As a result, although the sharpness of the formed directivity is slightly lost as shown in FIG. 9, the norm of w(ω) is as shown in FIG. 10. Referring to FIG. 10, it is seen that the magnitude of the norm of the filter coefficient vector is smaller than that shown in FIG. 8. As a result, also in an actual environment in which an individual difference between the microphones or an electrical noise exists, it becomes possible to ensure the sound quality of the output signal.

FIG. 11 shows the above-mentioned processes in the filter coefficient vector generating unit 3 as a flowchart.

The filter coefficient vector generating unit 3 reads directivity (r) in a target direction first (step ST1). This process corresponds to reading r shown in the above equation (4). Further, the filter coefficient vector generating unit 3 calculates a matrix A(ω), as shown in the above equation (3) (step ST2). Next, the filter coefficient vector generating unit 3 performs singular value decomposition on the matrix A(ω) acquired in step ST2, and replaces singular values equal to or less than a threshold with 0 (step ST3). Then, the Moore-Penrose pseudoinverse matrix of the matrix A(ω) is acquired, and the equation (6) is calculated (step ST4). Finally, a filter coefficient vector w(ω) acquired in the equation (6) is outputted (step ST5).

As mentioned above, in the signal processing device of Embodiment 1, by suppressing the magnitude of the filter coefficient vector in such a way that the magnitude does not become excessive, the degradation in the sound quality of the output signal because of excessive increase of an individual difference between the microphones or an electric noise existing in an actual environment and then mixing of the increased difference or electric noise into the output signal can be prevented.

Further, although the process of calculating a pseudoinverse matrix is implemented using the singular value decomposition in many cases, the method of acquiring a pseudoinverse matrix after replacing small singular values with 0 can be implemented only by adding a very small change to the implementation that uses the singular value decomposition. Therefore, because the time required for the implementation and the time required for tests can be reduced, cost reduction of the device can be expected.

As explained above, because the signal processing device of Embodiment 1 includes: the multiple sonic sensors; the filter coefficient vector generating unit for generating a filter coefficient vector used for forming directivity in a target direction by using beamforming, while suppressing the filter coefficient vector in such a way that the filter coefficient vector has a value equal to or less than a setting value; and the beamforming unit for performing the beamforming on the basis of both observation signals acquired from the respective multiple sonic sensors, and the filter coefficient vector generated by the filter coefficient vector generating unit, to form directivity in the target direction, and for outputting a signal in which a sound having the formed directivity is emphasized, the degradation in the sound quality of the output signal, the degradation being caused by an individual difference between the sonic sensors or an electrical noise, can be avoided.

Further, because in the signal processing device of Embodiment 1, the filter coefficient vector generating unit generates a filter coefficient vector whose norm is equal to or less than a setting value, by using the singular value decomposition, the time required for implementation and the time required for tests can be reduced and cost reduction can be achieved.

### Embodiment 2

In Embodiment 2, a filter coefficient vector generating unit 3 is configured so as to generate a filter coefficient vector by using L2 regularization. Because each of the other components is the same as that of Embodiment 1 shown in FIG. 1, an explanation will be omitted hereafter.

In Embodiment 1, the filter coefficient vector generating unit 3 calculates a filter coefficient vector w(ω) by using singular value decomposition. On the other hand, there are other methods of suppressing the magnitude of a filter coefficient vector. For example, there is a method of adding a penalty term for increase in the norm of w(ω) to an error function shown in the equation (5). This method is called L2 regularization, and the filter coefficient vector generating unit 3 of Embodiment 2 generates a filter coefficient vector by using this L2 regularization.

In Embodiment 2, an error e of the equation (5) in Embodiment 1 is modified as shown in the following equation (7). A denotes a parameter for adjusting the contribution of the penalty.

e=∥A(ω)w(ω)−r∥²+λ∥w(ω)∥² (7)

When e in the equation (7) is differentiated with respect to w(ω) and the differentiating result is set to be equal to 0, a filter coefficient vector w(ω) that minimizes e is acquired as shown in the following equation (8). H denotes Hermitian transpose and I denotes an identity matrix.

w(ω)=(A(ω)^{H}A(ω)+λI)⁻¹A(ω)^{H}r (8)

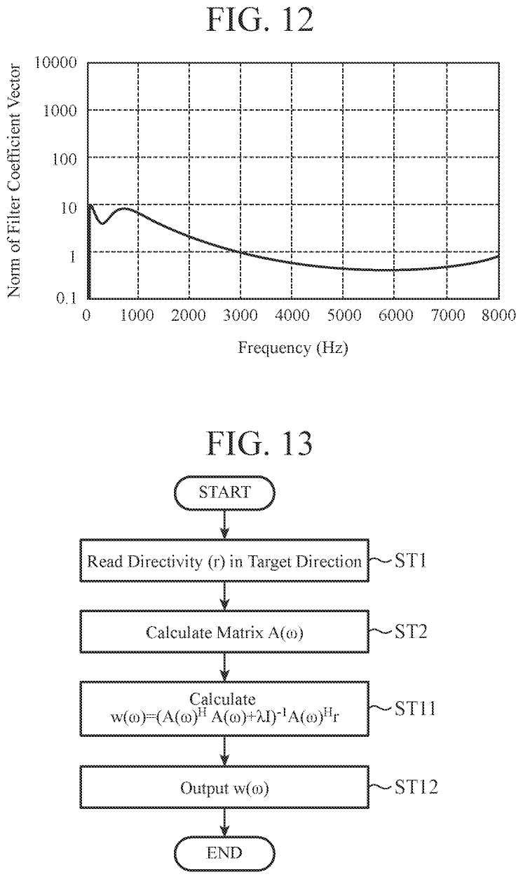

In the method based on the L2 regularization, when the norm of w(ω) is plotted for each frequency, the norm is as shown in FIG. 12. FIG. 13 is a flowchart showing an operation in the filter coefficient vector generating unit 3. In the flowchart of FIG. 13, steps ST1 and ST2 are the same as those of the operation of Embodiment 1 shown in FIG. 11. Next, the filter coefficient vector generating unit 3 of Embodiment 2 calculates the equation (8) in step ST11. Then, the filter coefficient vector w(ω) acquired in the equation (8) is outputted (step ST12).

In Embodiment 2, it can be seen from FIG. 12 that the value of the filter coefficient vector calculated on the basis of the L2 regularization is continuous in comparison with that of the filter coefficient vector shown in FIG. 10 and based on the singular value decomposition. More specifically, because the value of each of the elements of the filter coefficient vector based on the L2 regularization does not steeply vary dependently on the frequency, it can be expected that the sound quality of the output signal is improved.

As explained above, because in the signal processing device of Embodiment 2, the filter coefficient vector generating unit generates a filter coefficient vector by using the L2 regularization, a further improvement in the sound quality of the output signal can be achieved.

### Embodiment 3

In Embodiment 3, it is configured that a threshold for the norm of a filter coefficient vector is provided for a filter coefficient vector generating unit 3, and the filter coefficient vector generating unit 3 generates a filter coefficient vector having a value equal to or less than this threshold. Because each of the other components is the same as that of Embodiment 1 shown in FIG. 1, an explanation will be omitted hereafter.

The method of suppressing the magnitude of a filter coefficient vector by using the singular value decomposition in Embodiment 1 and the method of suppressing the magnitude of a filter coefficient vector by using the L2 regularization in Embodiment 2 need to be provided with, as their respective parameters, a threshold for singular values and a coefficient of a penalty term. Because within what range each of the norms of filter coefficient vectors generated using these parameters falls is not self-evident, trial and error are needed for an adjustment of each of the parameters. In contrast, if a range of values that the norm of a filter coefficient vector can have is explicitly specified, a trial-and-error parameter adjustment becomes unnecessary. Accordingly, in Embodiment 3, a range of values that the norm of a filter coefficient vector can have is explicitly specified, as a threshold, for the filter coefficient vector generating unit 3, and the filter coefficient vector generating unit 3 generates a filter coefficient vector whose norm is equal to or less than this threshold.

For example, there is a method of, when a constraint that the norm of a filter coefficient vector w(ω) must be equal to or less than ψ is imposed on the filter coefficient vector generating unit 3, after calculating w(ω) first by using a simple method as shown in the equation (6), in a frequency band in which the norm of w(ω) exceeds ψ, acquiring w(ω) that minimizes an error e under a constraint that the norm of w(ω) must be equal to ψ. More specifically, under the constraint that the norm of a filter coefficient vector must be equal to or less than the threshold, the filter coefficient vector generating unit 3 generates a filter coefficient vector that causes an error between directivity in a target direction and directivity formed by a beamforming unit 4 to be equal to or less than a setting value. Here, although it is difficult to analytically acquire w(ω) that minimizes the error e under the constraint that the norm of w(ω) must be equal to ψ, a numerical solution can be acquired by using a Newton's method or the like.

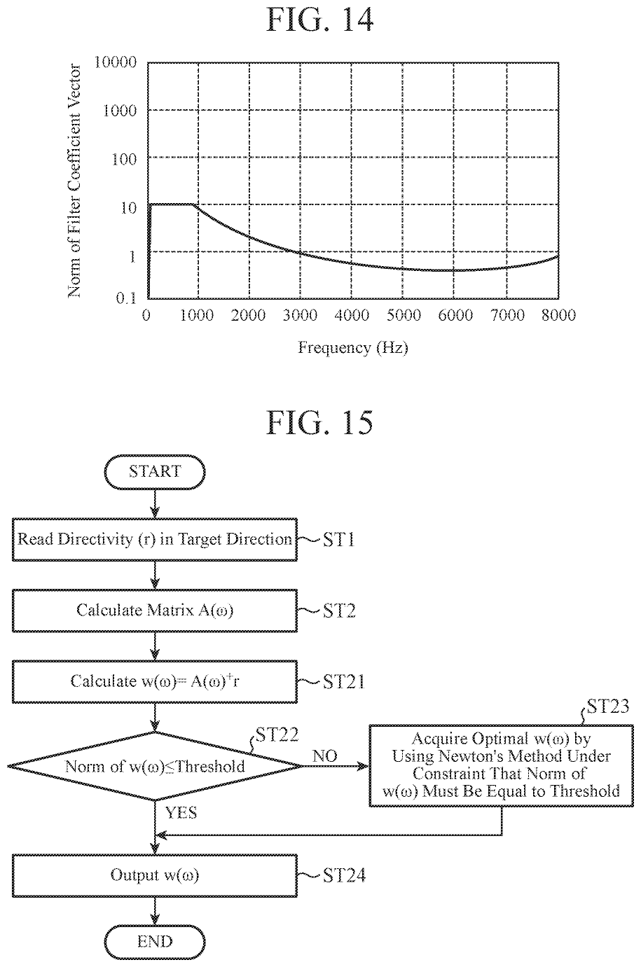

When the filter coefficient vector generating unit 3 calculates w(ω) by using the above-mentioned method after setting ψ=10, the norm of w(ω) is as shown in FIG. 14. FIG. 15 is a flowchart showing an operation in the filter coefficient vector generating unit 3. In the flowchart of FIG. 15, steps ST1 and ST2 are the same as those of the operation of Embodiment 1 shown in FIG. 11. Next, the filter coefficient vector generating unit 3 of Embodiment 3 calculates the equation (6) (step ST21). In addition, it is determined whether or not the norm of acquired w(ω) is equal to or less than the threshold (step ST22). When, in step ST22, the norm has a value exceeding the threshold, optimal w(ω) is acquired by using the Newton's method under the constraint that the norm of w(ω) must be equal to the threshold (step ST23), and that w(ω) is outputted (step ST23). In contrast, when, in step ST22, the norm of w(ω) is equal to or less than the threshold, that w(ω) is outputted (step ST24) and the operation is ended.

As mentioned above, in Embodiment 3, by making it possible to explicitly specify the range of values that a filter coefficient vector can have, the trial-and-error parameter adjustment becomes unnecessary, and the installation cost of the device can be reduced.

Further, in Embodiment 3, because, in the frequency band in which the norm of w(ω) exceeds ψ, w(ω) that minimizes the error e under the constraint that the norm of w(ω) must be equal to ψ is acquired, directivity closest to the directivity in the target direction within the range of values that the filter coefficient vector can have is formed, and therefore it becomes possible to correctly emphasize a sound coming from the target direction, while minimizing the influence of an individual difference between the microphones and electrical noises.

As explained above, because in the signal processing device of Embodiment 3, the filter coefficient vector generating unit is provided with the norm of a filter coefficient vector as a threshold, and generates a filter coefficient vector whose norm is equal to or less than the threshold, an adjustment of the parameter can be performed promptly, and the installation cost of the device can be reduced.

Further, because in the signal processing device of Embodiment 3, under the constraint that the norm of a filter coefficient vector must be equal to or less than the threshold, the filter coefficient vector generating unit generates a filter coefficient vector that causes an error between directivity in a target direction and directivity formed by the beamforming unit to be equal to or less than a setting value, it becomes possible to correctly emphasize a sound coming from the target direction, while minimizing the influence of an individual difference between the sonic sensors and electrical noises.

It is to be understood that any combination of two or more of the above-mentioned embodiments can be made, various changes can be made in any component according to any one of the above-mentioned embodiments, and any component according to any one of the above-mentioned embodiments can be omitted within the scope of the present disclosure.

### INDUSTRIAL APPLICABILITY

As mentioned above, the signal processing device according to the present disclosure is one that acquires a signal in which a sound coming from a specific direction is emphasized by performing signal processing on observation signals acquired from a sensor array including multiple sonic sensors, and is suitable for use in voice recognition systems and equipment monitoring systems.

### REFERENCE SIGNS LIST

1 signal processing device, 2 microphone array, 3 filter coefficient vector generating unit, 4 beamforming unit, and 5 output device.

1. A signal processing device comprising:
multiple sonic sensors;
a processor to execute a program; and
a memory to store the program which, when executed by the processor, performs processes of,
generating a filter coefficient vector used for forming directivity in a target direction by using beamforming, while suppressing the filter coefficient vector in such a way that the filter coefficient vector has a value equal to or less than a setting value; and
performing the beamforming on a basis of both observation signals acquired from the respective multiple sonic sensors, and the filter coefficient vector generated, to form directivity in the target direction, and outputting a signal in which a sound having the formed directivity is emphasized.

2. The signal processing device according to claim 1, wherein the processes include generating a filter coefficient vector whose norm is equal to or less than a setting value, by using singular value decomposition.

3. The signal processing device according to claim 1, wherein the processes include generating a filter coefficient vector by using L2 regularization.

4. The signal processing device according to claim 1, wherein the processes include being provided with a norm of a filter coefficient vector as a threshold, and generating a filter coefficient vector whose norm is equal to or less than the threshold.

5. The signal processing device according to claim 4, wherein the processes include under a constraint that a norm of a filter coefficient vector must be equal to or less than the threshold, generating a filter coefficient vector that causes an error between directivity in the target direction and the directivity formed to be equal to or less than a setting value.
